(19) United States
(12) Patent Application Publication
(10) Pub. No.: US 2014/0190690 A1
(43) Pub. Date: Jul. 10, 2014

(54) OIL FORMULATION FOR PREVENTING WATER PENETRATION IN UNDERGROUND FORMATIONS

(71) Applicant: Arnaud CADIX, Paris (FR)

(72) Inventor: Arnaud CADIX, Paris (FR)

(73) Assignee: Rhodia Operations, Aubervilliers (FR)

(21) Appl. No.: 14/151,094

(22) Filed: Jan. 9, 2014

Related U.S. Application Data
(63) Continuation of application No. 12/667,676, filed on Apr. 27, 2010, now abandoned.

(30) Foreign Application Priority Data
Jul. 5, 2007 (FR) 0704850

(51) Int. Cl. C09K 8/584; E21B 43/16

(52) U.S. Cl. CPC C09K 8/584; E21B 43/16
USPC 166/270; 507/245

(57) ABSTRACT

The present invention relates to the use of an oil formulation in the field of the oil industry, in particular for the prevention of water penetration. The formulation according to the invention is in particular intended to be injected into underground formations, such as injection wells or production wells.

### CROSS-REFERENCES TO RELATED APPLICATIONS

This application is a continuation of U.S. application Ser. No. 12/667,676, now abandoned, which is a U.S. national phase filing of International Application No. PCT/EP2008/057863, filed Jun. 20, 2008, which claims the benefit of French Application No. FR 07/04,850, filed Jul. 5, 2007, the disclosures of each of which are incorporated herein by reference in their entireties.

### BACKGROUND OF THE INVENTION

The present invention relates to the use of an oil formulation in the oil industry field, especially for the prevention of water penetration. The formulation according to the invention is especially intended to be injected into subterranean formations, such as injector wells or production wells.

During hydrocarbon production water is injected via injector wells so as to flood the oil-bearing rocks, also called formations, for the purpose of pushing the oil into a production well. As the formations mature, zones containing predominantly water develop. The flooding then preferably takes place via these zones and water production greatly increases at the expense of oil production.

A few, somewhat unreliable, technical solutions exist for preventing this phenomenon, but the results often remain random owing to the development of complex wells. This is because the growing number of mature fields, the development of complex wells, such as horizontal, subsea or multi-branched wells, and the reliability problems of down-hole separation techniques have considerably increased the interest of oil producers in auto-selective treatments for preventing penetration of water that can be injected directly (“bullhead” injection) into the reservoir formation, i.e. without zone isolation by specific equipment.

The object of the formulations according to the present invention is to lastingly reduce, in a selected manner, the permeability of the water-containing formation zones by injecting a particular oil formulation into the formations.

### BRIEF SUMMARY OF THE INVENTION

The present invention relates in part to a liquid oil formulation comprising: (a) a compound comprising at least two isocyanate functional groups; (b) a surfactant; and (c) an aromatic oil capable of dissolving compounds (a) and (b). The present invention also relates to a method of manufacturing the aforementioned formulation and a method for using the same.

The present invention further relates in part to a water-in-oil emulsion comprising a continuous phase which comprises an aromatic oil and wherein the water/oil interface is at least partially covered with a polyurea-type polymer obtained by hydrolysis and condensation of a compound comprising at least two isocyanate functional groups and wherein said aromatic oil is capable of dissolving said compound comprising at least two isocyanate functional groups and a surfactant. The present invention also relates to a method of manufacturing such an emulsion.

### DETAILED DESCRIPTION OF THE INVENTION

The liquid oil formulation according to the present invention comprises at least the following compounds:
(a) a compound comprising at least two optionally blocked, isocyanate functional groups;
(b) a surfactant; and
(c) an aromatic oil capable of dissolving compounds (a) and (b).

The expression “oil capable of dissolving compounds (a) and (b)” is understood to mean an oil capable of dissolving at least 10% by weight of compounds (a) and (b), especially at a temperature of 50° C. A single-phase solution is thus obtained.

When this formulation according to the invention is injected into a formation, it spontaneously generates an emulsion in the presence of water through the action of surfactants (b) in contact with the water or the aqueous medium. Since compounds (a) comprising at least two isocyanate functional groups hydrolyzed in the presence of water in an amine form, they may then condense with the isocyanates carried by the neighboring molecules, especially according to the reaction scheme below:

R—NCO+H₂O→R—NH₂+CO₂

R—NH₂+R′—NCO→R′—NH—CO—NH—R.

As a consequence, when the oil formulations according to the invention are injected into a formation and when petroleum oil is encountered, the formulation will mix in a miscible manner with the petroleum oil. However, when water is present, an emulsion will be spontaneously generated and, by hydrolysis/condensation, the water droplet interfaces will stiffen and block any flow out of this zone. This will result in durable plugging of the water-containing zone and will increase the hydrocarbon production yield.

The formulation according to the invention is thus used for selectively reducing the water permeability in higher-permeability drains, thereby promoting: 1) greater production (reduction in water/oil ratio); 2) more effective flooding of lower-permeability layers, in general those containing still mobilizable oil; and 3) water diversion toward less-permeable zones and therefore less-well flooded in water-injection draining processes.

One advantage of the process employing the formulations of the present invention also lies in the fact that it can be applied to formations without having to isolate or protect the hydrocarbon production zone or zones during the formulation injection phase.

The formulation according to the invention also has the other advantages of being stable, of having a low viscosity, and therefore of being easily injectable into the formation, and of comprising chemical compounds that easily dissolve.

Moreover, owing to the fact that it is a chemical reaction that results in plugging, it is possible to adapt the isocyanate reaction time by adding catalyst or, conversely, by using a blocked or masked isocyanate that will react only at high temperature. Thus, depending on the temperature of the formation, the penetration of the formulation into the formation may be adjusted. The treated portions may be relatively thick, thereby limiting the risk of circumventing the plugged zones.

### Compound (a)

The isocyanate compounds according to the invention are particularly chosen according to their solubility in oil. This is because isocyanate functional groups are polar and a high degree of functionalization may limit the solubility thereof in less polar oils. In practice, it is possible to envision, beyond the range of monomers, conventional biurets and trimers to produce isocyanate prepolymers of very low polarity, for example by reacting them with fatty amines.

Compounds comprising at least two isocyanate functional groups, for example two or three isocyanate functional groups are used.

For example, it is possible to use the preferably chosen diisocyanates in the following list: isophorone diisocyanate, toluene diisocyanate, biphenyl diisocyanate, dimethoxy-4,4′-biphenyl diisocynate, dimethyl-4,4′-biphenyl diisocyanate, 1,3-bis (isocyanatomethyl) benzene, phenyl diisocyanate, tolylene diisocyanate, diisocynatohexane, diisocyanatooctane, diisocyanatobutane, xylene diisocyanate, octamethylene diisocyanate and phenylene diisocyanate.

It is also possible to use diisocyanate polymers, such as polyhexamethylene diisocyanate. In particular, diisocyanate trimers, for example isophorone diisocyanate trimer or hexamethylene diisocyanate trimer, may be used.

Compounds (a) may optionally be masked or blocked, especially those capable of forming an isocyanate functional group in situ under the influence of heat. As a type of blocked isocyanate functional group, mention may be made of isocyanate functional groups blocked by methyl ethyl ketoxime groups.

The oil formulation may comprise one or more compounds (a). In the formulation, the concentration of compound (a) may be between 1 and 15% by weight, especially between 3 and 10% by weight.

A catalyst for catalyzing the isocyanate condensation hydrolysis reaction, such as for example 1,4-diazabicyclo[2.2.2]octane (DABCO), may optionally be added to the formulation.

### Compound (b)

The surfactants according to the invention are in particular chosen according to their solubility in oil. As regards the choice of surfactants, in particular it is preferred to use those having a low HLB thereby promoting the formation of inverse (water-in-oil) emulsions.

For example, the following may be used as surfactants:
fatty acids, such as for example stearic acid, oleic acid, linoleic acid or palmitic acid and/or mixtures thereof. For example, mention may be made of tall oil fatty acids (TOFAs) consisting of about 50% oleic acid, 30 to 40% linoleic acid and a few percent of stearic acid, palmitic acid and linolenic acid. This product is commercially available under the name Resinoline BD30 supplied by the company DRT. The fatty acids may be used in their acid form, or completely or partially neutralized by a base soluble in oil, such as for example trimethylamine, triethylamine or preferably N,N-dimethylcyclohexylamine;
amides derived from fatty acids, such as for example coco fatty acid monoethanolamide and diethanolamide (cocamides sold by Rhodia under the names Alkamide C212 and Alkamide DC-212/S) or erucic acid monoethanolamide and diethanolamide;
hydrophobic acrylate/vinyl pyrrolidone diblock copolymers, such as those described in patent application WO 2003/068848 A2;
linear or branched, ethylene oxide/propylene oxide random or blocked copolymers, especially those sold by Rhodia under the names Antarox 17R2, Antarox L61 and Antarox LAEP 15;
sorbitan esters such as sorbitan oleate, such as the one sold by Rhodia under the name Alkamuls SMO, sorbitan isostearate, sorbitan sesquioleate and polyethoxylated sorbitan esters, such as pentaethoxylated sorbitan monooleate or pentaethoxylated sorbitan isostearate;
ethoxylated alcohols, such as ethoxylated tridecyl alcohol;
ethoxylated alkyl phenols, such as ethoxylated nonyl phenol and ethoxylated octyl phenol, especially with an ethoxylation number of less than 2;
ionic surfactants, such as for example alkyl alcohol ethoxy phosphates, tristyrilphenol ethoxy sulfates, dodecylbenzene sulfonates and C₁₄₋₁₆ olefin sulfonates;
zwitterionic surfactants such as, for example, cocamidopropyl betaine and cocamidopropyl hydroxysulataine; and
polymeric emulsifying surfactants, especially those sold under the names

Hypermer and Arlacel by the company ICI and described in the patents U.S. Pat. No. 4,504,276, U.S. Pat. No. 4,509,950 and U.S. Pat. No. 4,776,966.

An oil formulation may comprise one or more surfactants (b). In the formulation, the concentration of surfactant (b) may be between 0.5 and 20% by weight especially between 1 and 10% by weight and more preferably between 3 and 6% by weight.

A compound capable of neutralizing the surfactant, such as for example a tertiary amine such as N,N-dimethyl cyclohexylamine (DMCHA), may also be added to the formulation.

### Oil (c)

The aprotic oil used according to the invention is in particular nonmiscible with water and miscible with hydrocarbons. As explained above, the oil is aprotic because protic systems would react with isocyanates as soon as they are mixed therewith.

The term “oil” is considered to mean any liquid which, under normal temperature conditions, is hydrophobic and lipophilic and has low polarity. To give an indication, any liquid is considered to have a low polarity if its polar component (denoted by 8p) defined according to the Hansen parameters is less than or equal to 8 (J/cm³)¹².

The oil (c) may be an organic oil, a vegetable oil or a mineral oil.

In the case of an organic oil, this may comprise saturated or unsaturated fatty acids, saturated or unsaturated fatty acid esters, such as for example a diisobutyric ester or a diethyl ester, or an organic solvent such as for example xylene.

In the case of a mineral oil, this may be any type of petroleum cut, such as paraffinic mineral oils or naphthenic oils such as, for example, diesels, Isopar L, Exxsol D100 or Solvesso 200.

In the case of a vegetable oil this may be a palm oil, a rapeseed oil, a linseed oil or a sunflower oil.

The oil formulation may perfectly comprise one or more oils (c).

Preferably, the formulation has a flow viscocity of between 10 and 1000 cP and more preferably less than 100 cP, in particular at a temperature of 50° C.

It is also possible to add all types of additives to the formulation according to the invention, especially those conventionally used in the oil extraction field.

The following formulations may be mentioned as particularly appropriate formulations for the invention:

| Formulation | (a) | (b) | (c) |
|---|---|---|---|
| 1 | isophorone diiso- | TOFA | palm |
| | cyanate trimer | | oil |
| 2 | isophorone | mixture of TOFA and | palm |
| | diisocyanate trimer | dimethylcyclohexyl- | oil |
| | | amine | |
| 3 | hexamethylene di- | mixture of TOFA, | palm |
| | isocyanate trimer | dimethylcyclohexyl- | oil |
| | | amine and an alkyl | |
| | | alcohol ethoxy | |
| | | phosphate | |
| 4 | mixture of hexa- | mixture of TOFA and | diiso- |
| | methylene di- | dimethylcyclohexyl- | butyl |
| | isocyanate trimer | amine | acetate |
| | and isophorone di- | | |
| | isocyanate trimer | | |
| 5 | hexamethylene di- | mixture of TOFA and | Sol- |
| | isocyanate trimer | dimethylcyclohexyl- | vesso |
| | | amine | 200 |
| 6 | hexamethylene di- | mixture of TOFA, | xylene |
| | isocyanate trimer | dimethylcyclohexyla- | |
| | | mine and alkyl alco- | |
| | | hol ethoxy phosphate | |

Since the constituents of the formulation are miscible, it may be produced by mixing, especially by means of mixers, optionally using metering pumps adapted to the volume of formulation to be produced. For practical reasons, constituents (a) and (b) may be preassembled and stored, to be mixed with the oil (c) only at the moment of use.

The present invention also relates to a method of treating subterranean formations into which at least one oil formulation according to the present invention is injected. Optionally, the formulation may be injected into subterranean formations via wells.

The amounts of formulation injected will generally be around 10% to 90% and preferably 20% to 80% of the porous volume of the rock zone to be treated.

The field of use of the present application relates in particular to formations having a temperature between 20° C. and 300° C., preferably between 60° C. and 250° C. The salinity of the water in these formations is generally between 0.1 g/l and 350 g/l TDS, preferably between 0.1 g/l and 100 g/l TDS.

The formulation may be injected into subterranean formations in particular via injection wells and/or production wells, it being possible for the wells to be vertical wells, horizontal wells or wells with a complex architecture. For example, the wells may be open-hole wells or wells completed with gavel packs, perforatuted tubulars or liners.

The formulation is suitable for any type of subterranean formation, especially formations based on water-wettable or oil-wettable rock.

The invention thus relates the use of a formulation as defined above in the following fields: hydrocarbon extraction for the prevention of water penetration; profile control; chemical flooding; sand consolidation; waste-fill sealing; and zone abandonment.

The invention also relates to a water-in-oil emulsion in which the continuous phase comprises oil (c) and the water/oil interface is completely or partially covered with a polyurea-type polymer obtained by hydrolysis and condensation of compound (a).

A subject of the invention is also the manufacture of a water-in-oil emulsion as defined above, in which a formulation according to the invention is brought into contact with an aqueous medium. Optionally, said emulsion may be formed by agitation.

A specific language is used in the description so as to make the principle of the invention easier to understand. However, it should be understood that no limitation in the scope of the invention is envisioned by the use of this specific language. Modifications, improvements and perfections can in particular be envisioned by a person skilled in the technical art in question on the basis of his own general knowledge.

The term “and/or” includes the meanings “and”, “or” as well as all other possible combinations of the elements connected with this term.

Other details and advantages of the invention will become more clearly apparent of the light of the examples given below solely by way of indication.

### EXPERIMENTAL PART

The compounds used are given in Table 1.

TABLE 1

| Compounds | | % active | Supplier |
|---|---|---|---|
| Oil | Refined palm | 100% | Fluka |
| | oil | | |
| Isocyanate | Tolonate X IDT | 70% | Rhodia |
| | 70B | | |
| | Rhodocoat X EZ- | 70% | |
| | D450 | | |
| Surfactant | Tall oil fatty | 100% | Novance |
| | acid (TOFA) | | |
| Neutralizer | N,N-dimethyl | 100% | Aldrich |
| | cyclohexylamine | | |
| | (DMCHA) | | |

The various compounds were in the liquid state and mixed without any special precautions with agitation using a bar magnet to obtain the formulation given in Table 2.

TABLE 2

| Compound | (g) | % active |
|---|---|---|
| Refined palm oil | 20 | / |
| Tolonate X IDT | 2 | 6.1 |
| 70B | | |
| TOFA | 0.6 | 2.6 |
| DMCHA | 0.2 | 0.9 |

This formulation was emulsified with a 2% NaCl solution, this salt concentration being representative of the water encountered in certain formations. A water/oil ratio of 50/50 wt % was chosen. The emulsification took place spontaneously and the mixture was simply homogenized by shaking the pillboxes.

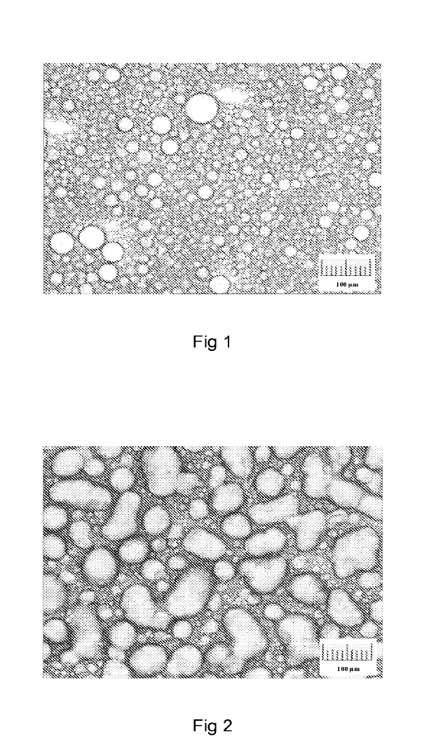

The emulsion thus formed was a water-in-oil dispersion and the particle size distribution was relatively broad, with particles between 1 and 100 μm, as shown in FIG. 1. This emulsion, heated to a temperature of 65° C., cures in a few hours. After 24 hours, the stiffened emulsion had larger droplet sizes than in the initial emulsion, but still with a maximum size of approximately 100 μm, as shown in FIG. 2.

FIG. 1 shows a microscope image (magnification ×100) of the formulated-oil/water emulsion of the experimental part, after mixing.

FIG. 2 shows a microscope image (magnification ×100) of the formulated-oil/water emulsion of the experimental part, after 24 hours at 65° C.

Moreover, the heated emulsion becomes solid after a few hours at 90° C.

Rheology measurements were carried out so as to estimate the setting time of these emulsions and their mechanical properties. The elastic modulus and loss modulus of the emulsion were measured as a function of time and using an AR2000 Rheometer (TA instruments, Surrey, Great Britain) with a helical geometry akin to a Couette type geometry.

Table 3 shows the values of the elastic moduli (G′) as a function of time for the formulation alone and for the emulsion comprising 50% formulation and 50% water containing 2% NaCl, these two specimens being heated to 90° C.

TABLE 3

| Time (min) | G′ (formulation) (Pa) | G′ (emulsion) (Pa) |
|---|---|---|
| 5 | not measurable | 0.5 |
| 60 | 0.015 | 290 |
| 120 | 0.013 | 690 |

This table thus shows that the elastic modulus of the formulation according to the invention remains constant with very low values at the measurement sensitivity limit of the apparatus. In the case of the emulsion, a very substantial increase in the elastic modulus is observed, corresponding to the solidification of the emulsion.

These trials show that the oil formulation remains stable under the application temperature conditions, i.e. here at 90° C. Thus if an oil-containing rock is encountered, the system will remain fluid and the flow will remain possible. In contrast, if water is encountered, the emulsion formed by the formulation upon contact therewith will cure in a few hours and the solid thus formed will permanently plug this zone.

1. A liquid oil formulation comprising:
(a) a compound comprising at least two isocyanate functional groups;
(b) a surfactant; and
(c) an aromatic oil capable of dissolving compounds (a) and (b).

2. The formulation of claim 1, wherein compound (a) is isophorone diisocyanate, toluene diisocyanate, biphenyl diisocyanate, dimethoxy-4,4′-biphenyl diisocynate, dimethyl-4,4′-biphenyl diisocyanate, 1,3-bis (isocyanatomethyl) benzene, phenyl diisocyanate, tolylene diisocyanate, diisocynatohexane, diisocyanatooctane, diisocyanatobutane, xylene diisocyanate, octamethylene diisocyanate, or phenylene diisocyanate.

3. The formulation of claim 1, wherein compound (a) is a diisocyanate polymer.

4. The formulation of claim 1, wherein the concentration of compound (a) ranges from 1 to 15% by weight.

5. The formulation of claim 1, wherein the surfactant (b) comprises:
fatty acids;
amides derived from fatty acids;
hydrophobic acrylate/vinyl pyrrolidone diblock copolymers;
linear or branched ethylene oxide/propylene oxide random or block copolymers;
sorbitan esters;
ethoxylated alcohols;
ethoxylated alkyl phenols
ionic surfactants;
zwitterionic surfactants;
polymeric emulsifying surfactants;
or mixtures thereof.

6. The formulation of claim 1, wherein the surfactant (b) comprises a mixture of fatty acids.

7. The formulation of claim 1, wherein the concentration of surfactant (b) ranges from 0.5 to 20% by weight.

8. The formulation of claim 1, wherein the oil (c) comprises an organic oil, a mineral oil, a vegetable oil, or mixtures thereof.

9. The formulation of claim 1, wherein said the oil (c) comprises saturated or unsaturated fatty acids, saturated or unsaturated fatty acid esters, organic solvents, paraffinic mineral oils, naphthenic oils, palm oil, rapeseed oil, linseed oil, sunflower oil, or mixtures thereof.

10. A method of manufacturing a formulation according to claim 1, wherein said compound (a), said surfactant (b), and said aromatic oil (c) are mixed together.

11. A method of treating a subterranean formation, comprising injecting into said formation a formulation according to claim 1.

12. The method of claim 11, wherein said formulation is injected into said formation by an injection well and/or by a production well.

13. (canceled)

14. A water-in-oil emulsion comprising a continuous phase which comprises an aromatic oil and wherein the water/oil interface is at least partially covered with a polyurea-type polymer obtained by hydrolysis and condensation of a compound comprising at least two isocyanate functional groups and wherein said aromatic oil is capable of dissolving said compound comprising at least two isocyanate functional groups and a surfactant.

15. A method of manufacturing the water-in-oil emulsion of claim 14, wherein a liquid oil formulation is brought into contact with an aqueous medium, said formulation comprising:
(a) a compound comprising at least two isocyanate functional groups;
(b) a surfactant; and
(c) an aromatic oil capable of dissolving compounds (a) and (b).

16. The formulation of claim 1, wherein at least one of said isocyanate functional groups in said compound (a) is blocked.

17. The formulation of claim 3, wherein compound (a) is a diisocyanate trimer.

18. The formulation of claim 17, wherein compound (a) is a isophorone diisocyanate trimer or a hexamethylene diisocyanate trimer.

19. The formulation of claim 5 wherein said fatty acids are in their acid form or in a form completely or partially neutralized by a base soluble in said oil.

20. The formulation of claim 1, wherein said formulation is adapted to form a water-in-oil emulsion when contacted by an aqueous medium.

21. The method of claim 11, further comprising contacting an aqueous medium in the subterranean formation with said formulation, wherein the formulation and the aqueous medium form a water-in-oil emulsion comprising a water/oil interface, wherein the water/oil interface is at least partially covered with a polyurea-type polymer resulting from hydrolysis and condensation of the compound comprising at least two isocyanate functional groups.
